(19) United States
(12) Patent Application Publication
(10) Pub. No.: US 2007/0058654 A1
(43) Pub. Date: Mar. 15, 2007

(54) Arrangement and coupling device for securing data access

(76) Inventors: Johann Arnold, Wendelstein (DE); Wolfgang Bolderl-Ermel, Wendelstein (DE); Hendrik Gerlach, Erlangen (DE); Harald Herberth, Oberasbach (DE); Franz Kobinger, Nurnberg (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 10/564,211

(22) PCT Filed: Jul. 9, 2004
(86) PCT No.: PCT/EP04/07594

§ 371 Date: Jul. 25, 2006

(30) Foreign Application Priority Data
Jul. 10, 2003 (DE) 103 31 308.7

(51) Int. Cl. H04J 3/16

(52) U.S. Cl. 370/437

(57) ABSTRACT

The invention relates to a mechanism and a coupling device, a so-called secure switch, for securing data access of a first subscriber to a second subscriber, wherein the secure switch has a port that is configured to provide an endpoint of a tunnel to the second subscriber through which data can be securely transmitted via an insecure network. The tunnel is established in the secure switch in place of the downstream first subscriber. The invention is advantageous in that security functions can be integrated into existing networks at a later point in time by inserting secure switches.

### CROSS REFERENCE TO RELATED APPLICATIONS

This application claims priority to the German application No. 10331308.7, filed Jul. 10, 2003 and to the International Application No. PCT/EP2004/007594, filed Jul. 9, 2004 which are incorporated by reference herein in their entirety.

### FIELD OF INVENTION

The invention relates to a mechanism and a coupling device, referred to as a secure switch, for securing data access of a first subscriber or a plurality of subscribers, which are arranged in a first subnetwork of an automation network, to a second subscriber or a plurality of subscribers, which are arranged in a second subnetwork of an automation network.

### BACKGROUND OF INVENTION

Subscribers can, for example, be servers, programming devices, operating and monitoring stations, service mechanisms for maintenance or diagnosis, automation devices, decentral peripherals or field devices, for example measuring transducers or actuators, which are connected to each other in a common automation network for transmitting data. They are components of an automation system which is used for monitoring a technical process, for example a manufacturing process, and is known per se. Automation networks of this type were previously divided hierarchically into a plurality of levels, for example processing, automating and central command levels. In this case components of the respective level were connected to each other by a data transmission unit, referred to as a gateway. Automation components of the processing level and/or automation level were horizontally connected to each other by means of what is known as a field bus system and vertically connected to the next highest level, for example to the central command or control level, by means of an Ethernet bus system. Field busses are specifically oriented toward the requirements of automation engineering. Communications media and protocols for field busses are, as a rule, not common in offices. As access from the central command and control level to the automation or field level was only possible via gateways, hacker attacks on the lower levels of the automation network were made difficult. Nowadays automation components of a level are increasingly also horizontally connected by means of an Ethernet bus system. With the increasing spread of Ethernet to the lower levels of an automation network as well, the various levels are merging ever more closely and special gateways are no longer necessary from a purely communications engineering point of view. Hacker attacks are therefore more easily possible at the lower levels of an automation network as well.

A further trend is the increasing fusion of office and production networks which can be regarded as sections of an automation network. New problems result from this, in particular in terms of safety and security. Disruptions to the automation devices that a re introduced via the office network into the production network can potentially severely disrupt or affect production. The risks associated therewith, for example loss of production through to danger to human life, are often much higher than in the case o f disruptions which are limited to an office network. Disruptions to the production network that start in the office network can be caused for example by operating errors, for example owing to the input of incorrect IP addresses, viruses, Trojan horses or worms, which attempt to spread in the network via personal computers in the office network and which potentially also reach the production network area, also due to employees who, for example, try out TCP/IP network tools or due to attacks by employees inside the automation engineering system, which, if of a passive nature, can be called spying and if of an active nature, sabotage. It is therefore necessary to protect certain parts of the automation network against unauthorized access.

It is known from DE 101 24 800 A1 to exchange function- and/or device-related data between various devices of a process automation system so it is at least partially encrypted. This should allow flexible and, at the same time, secure handling of selected important data of the process automation system. Encryption is performed directly in the end terminals. This requires all end terminals that are involved in encrypted data transmission to be relatively powerful.

A chapter entitled “Bridging and IPsec” was made accessible to the public on the web page with the address www.thought.net/jason/bridgepaper/node9.html. A bridge is described which is augmented by IPsec capabilities. Messages entering one side of the b ridge in Ethernet format are output at the other side of the bridge encrypted in accordance with the IPsec protocol, which is located on layer 3 of the ISO -OSI 7-layer model, and can thus be transmitted, so as to be protected against access, via an insecure portion of the network. An application on automation networks is not described.

### SUMMARY OF INVENTION

An object of the invention is to provide an arrangement and a secure-switch for securing data access of a first subscriber or a plurality of subscribers, which are arranged in a first subnetwork of an automation network, to a second subscriber or a plurality of subscribers, which are arranged in a second subnetwork of an automation network, that are distinguished by particularly low expenditure.

This object is achieved by the claims.

In the context of this invention, the term “tunnel” is taken to mean a connection between two or more subscribers of the automation network, which advantageously ensures secure data transmission with respect to authenticity, integrity and/or confidentiality. All message data, in other words user data and header information of a message, is transmitted in a secure manner by the tunnel. Shared secrets are required to establish a tunnel. If the tunnel is established between two partners, both partners must have the same shared secret or a mutually matching public/private key pair. If the tunnel is to be expanded to more than two partners (global tunnel), shared keys for example must be distributed among all participating subscribers. If public/private keys are used and there are more than two partners, all partners must have key pairs of this type between themselves. The respective key pair that applies to the current partner must be used when encrypting or decrypting data. The use of public/private key pairs is rather complicated and expensive, however, particularly in relatively large systems. The process is simple in the case of a shared secret as all subscribers have the same key which can be used for all subscribers.

The invention allows inexpensive protection of subscriber networks, for example automation cells, within the production network in addition to decoupling of office network and production network. Consequently, unintentional interactions, such as may occur in a starting-up phase of sections, can be avoided. Potential internal attackers who are given access to the production network, for example employees in assembly companies, are considerably limited in their possibilities for disrupting the automation system.

A tunnel end point is produced in a switch with software and/or hardware modules. The switch assumes a substitute function for devices which are not themselves capable of producing a tunnel end point. Thus the mechanism for securing data access can advantageously be used without reaction in existing automation networks. “Without reaction” in this connection means that the subscribers to the existing network do not have to be changed with respect to their addressing, the respective subnetwork or their parameterization. For this purpose, the tunnel is advantageously allocated to the respective subscriber by using the respective subscriber address, i.e. by using the address of the subscriber or subscribers for which the tunnel is substitutionally established by the mechanism. An IP address is preferably used as the subscriber address. Alternatively the Ethernet MAC address may be used for this purpose. The decision regarding which tunnel is to be used in the event of a desired data transmission is therefore made by using the addresses of the end terminals involved. In the case of IP capable subscribers, this may be the IP address; in devices which communicate via level 2 protocols, the MAC address. The resources necessary for establishing the tunnel are only required in the preceding switch, so the subscribers or subnetworks located thereafter manage with few resources. In addition, in what are known as switched networks a switch that is present anyway may be replaced by a secure switch for securing the data traffic. Use of the invention is subsequently associated with particularly low expenditure.

By using a secure switch as a substitute for individual subscribers or a plurality of subscribers which are located in a subnetwork, the mechanism for securing data access may be subsequently integrated into existing networks without relatively major rearrangement of the subscriber parameterization being necessary. The automation devices, which may potentially be old devices with low power resources, can remain unchanged. Only the secure switches as substitutes have to be coordinated with each other. Apart from the aspect of continued use of the old devices, this property may, for example, also be significant if the parameterization on the automation devices themselves may no longer be altered, for example because they have been removed by test centers, and modifications would require new tests or verifications. The subscribers connected downstream are disconnected from the insecure network by the secure switch as a substitute. As a rule they can implicitly accept communication from outside via the tunnel. With other forms of communication however there must be a test as to whether it is acceptable for the subscribers. This test requires resources. In addition a large number of broadcast messages or additional loads may lead to considerable loading of the tunnel end point, for example owing to UDP flooding attacks from the office network. If the tunnel end point is produced in the secure switch as a substitute, the load falls to this. The resources of the subscribers connected downstream can continue to be used in the automation network completely for automation engineering functions. If the subscribers' load had to be overcome, the subscribers could be impaired when fulfilling their automation engineering functions and, in the worse case, fail. Without substitutes the automation devices would be visible immediately as network subscribers on the insecure network and would thus also be vulnerable to attack. In the event of errors in the implementation of a tunnel protocol executed on the sub scribers themselves, operation thereof could be impaired in the event of attacks.

As the use of secure tunnels ensures that the data is protected from interception and modification (privacy, integrity), in addition to protecting against access, data can be transmitted, for example between two secure switches, via an insecure network. No security requirements are specified for the security of the transmission media in this sector. Tunnels in pairs, i.e. tunnels between two subscribers, allow the individual bilateral connections to be separated from each other with respect to transmission security. A global tunnel, i.e. a tunnel with more than two end points, can contribute to a saving in resources, which are often limited in automation devices in particular, compared with a tunnel in pairs. Mixing of tunnels in pairs and global tunnels, i.e. the simultaneous existence of different types of tunnel, allows improved scaling of the automation network. Particularly critical communications connections are created via tunnels in pairs, less critical connections via a common, global tunnel.

As, in contrast to office engineering, networks are configured in automation engineering, with a suitably designed configuration tool a series of parameterization and/or configuration data can be derived for the secure switch from this configuration. Thus no, or only little, IT knowledge on the part of a user is required for configuration. Conventionally the devices of the automation system and its network connections are configured and/or parameterized. Configuring of the communications connections is necessary to allow communication between the devices. The following may be derived, by way of example, as information from configuration of the network and the communications subscribers:

which device is communicating with which other device,

which protocols are used during communication,

what direction communication is taking place in and/or

via which optionally alternative paths communication can proceed.

A configuration tool can be expanded such that the security devices and, in particular, the secure switch used are also configured. If the secure switch in a connection is placed between two subscribers, the following information may also be derived, by way of example, from the configuration:

which networks and/or devices are located downstream of the secure switch,

which devices downstream of the secure switch communicate with which devices downstream of a second secure switch,

which devices downstream of the secure switch are themselves capable of establishing secure tunnels, so the secure switch can easily pass along encrypted messages.

From this type of information, information may be derived for the parameterization of the secure switch such as:

between which secure switches and/or subscribers secure tunnels are to be established and which type of tunnel connections these are (for example host to network, network to network, host to host),

between which secure switches and/or subscribers authentication n is necessary and which of these devices must have shared secrets or where what type of certificates are required with a certificate-based authentication and/or

which security rules are to be employed for which connections.

By way of example, connections from a programming device to an office computer can be operated in the office network without security, i.e. data is transmitted by the secure switch, while connections from a programming device to an automation cell are to be secured via an additional secure switch, i.e. a tunnel should be established between the two secure switches.

The use of layer 3 (network layer) of the ISO -OSI 7-layer model as a basis for the tunnel protocol provides the advantage of compatibility with the infrastructure existing in the automation networks. Thus level 2 packets, as sometimes occur in automation engineering, may also be tunneled.

Production of a tunnel end point by a layer 3 port with IPsec protocol of a secure switch, which is constructed as an Ethernet switch, i s particularly advantageously expedient. A proven protocol that is already very common outside of automation engineering is thus used. In the case of IPsec as a basis for the tunnel protocol, personal computers with conventional operating systems can operate as the tunnel end point.

In principle, a layer 4 switch which produces a tunnel end point with a layer 4. protocol, for example based on SSL, Kerberos or SSH instead of the IPsec protocol, could also be used as the secure switch. Of course for transmission through the tunnel Ethernet packets have to be packed in IP packets in advance in this case as well, for example using EtherIP, before they can be sent through the security protocol, in this case SSL, Kerberos or SSH.

If the secure switch has at least one port, which is constructed as a WLAN end point and is capable of producing a tunnel end point, complex wiring and space requirements may be reduced. In this case the design of the secure switch does not place any particular security requirements on the WLAN end point. For example WEP (Wired Equivalent Privacy) security architecture, which allows data encryption and possible authentication of a subscriber device with respect to the WLAN end point, is not required for the WLAN. Of course existing security mechanisms in the WLAN end point, for example MAC address restrictions, continue to be retained. However, by using a tunnel the WLAN end point can accordingly be configured via secure communications paths. Setting of admissible MAC addresses in the WLAN end point is cited by way of example. The end of the tunnel is advantageously located between the WLAN end point and the central switch matrix of the secure switch.

The constructional configuration of the switch is advantageously chosen such that it is suitable for use in an automation system. Depending on the application it is constructed in such a way that the requisite class of protection, for example protection against dust, water or explosion, is adhered to. With suitable selection of the design a to p hat rail or cabinet mounting is possible. A power supply with low voltage, for example 24 v, is advantageous.

If a port suitable for producing a tunnel end point can be distinguished from other ports of the secure switch by a marking, this has the advantage that the cabling is simplified and cabling errors are reduced.

A user's feeling of security is increased if the state is displayed by a visually discernible marking. If a port of a secure switch allows transmission of secure and in secure messages it can be labeled with a marking that can be changed over.

One possible embodiment is, for example, a light-emitting diode which can change over in terms of color. If in the instantaneous configuration only secure transmission may take place, it illuminates in green; if in another case secure and insecure transmission may take place in the instantaneous configuration it illuminates in yellow, and if only insecure transmission is possible it changes to red. In addition to the configuration display a dynamic traffic display may also be advantageous which, to improve visibility, operates with appropriate extension of the display time. For example any packet transmitted insecurely can be displayed by a light-emitting diode that briefly illuminates in yellow and any packet transmitted securely can be displayed by a light-emitting diode that briefly illuminates in green. Mixed transmission results in flickering of the light-emitting diode. It is also advantageous for network management if the display can be interrogated automatically as to the security status of the port, for example via SNMP protocol.

### BRIEF DESCRIPTION OF THE DRAWINGS

The invention and configurations and advantages will be described in more detail hereinafter with reference to the drawings in which an exemplary embodiment of the invention is shown and in which:

FIG. 1 shows a block diagram of an automation network and

FIG. 2 shows a block diagram of a secure switch.

### DETAILED DESCRIPTION OF INVENTION

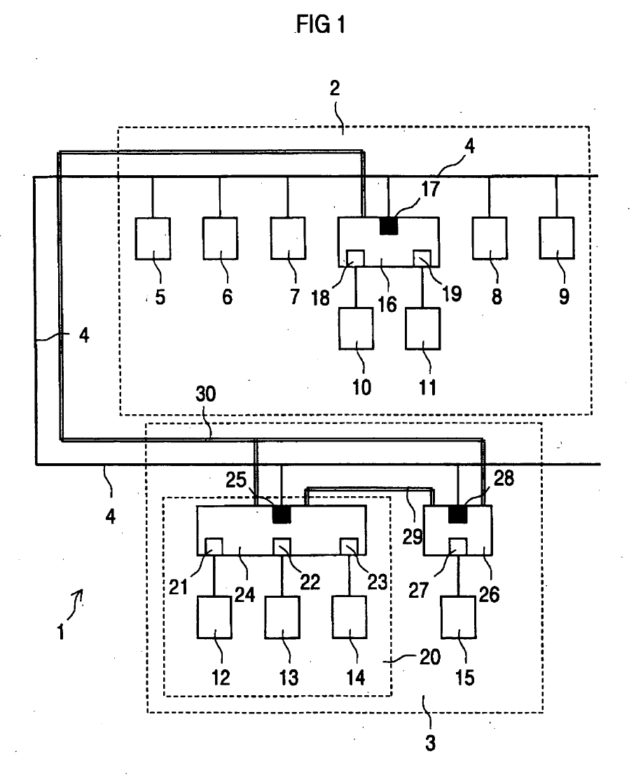

FIG. 1 shows the basic construction of an automation network 1. Substantially shown are the devices involved in communication, which are frequently designated subscribers, and the physical connections required for this purpose. Further components of the automation system in a process engineering system are not shown for the sake of clarity. The automation network 1 is divided in this illustration into an office network 2 and a production network 3. This illustration was selected following the previous situation in which office network and production network were constructed separately from each other and connected to each other by a gateway. Hacker attacks introduced via the office network could therefore only pass into the production network with difficultly. In the illustrated exemplary embodiment, office network 2 and production network 3 are directly connected to each other via a line 4 and are thus effectively fused together. Data is transmitted in the two networks for example with Ethernet TCP/IP. Devices that are not process-oriented are located in the office network 2, for example a server 5, office PCs 6, 7, 8 and 9, an operating and monitoring device 10 and programming device 11, some of which can be associated with a central command level of conventional structure. Process-oriented devices, for example an automation device 12, a measuring transducer 13, an operating and monitoring device 14 and a programming device 15, are arranged in the production network 3. A secure switch 16 is connected upstream of the operating and monitoring device 10 as well as the programming device 11 and is connected to the mains power line 4 by a secure port 17, i.e. a port which is suitable for producing a tunnel end point. The devices 10 and 11 are connected to ports 18 and 19 of the secure switch 16 which do not have to have a security device of this type. Devices 12, 13 and 14 are arranged in the production network 3 in a subnetwork 20 and are connected for this purpose to ports 21, 22 and 23 of a secure switch 24. A secure port 25 of the secure switch 24 is connected to the connecting line 4 of the automation net work 1. A secure switch 26 with a port 27 and a secure port 28, which is connected to the programming device 15 and the connecting line 4, is connected upstream of the programming device 15. To secure the data transmission between the programming device 15, the automation device 12, the measuring transducer 13 and the operating and monitoring device 14, a tunnel 29 in pairs is established between the secure switch 24 and the secure switch 26. This tunnel is produced with a symmetrical encryption method in which the two secure switches 24 and 26 have a secret key. A global tunnel 30 connects the secure switches 24, 26 and 16 to each other, which have a shared secret for encryption and decryption of the messages. The tunnels 29 and 30 are shown separate from the connecting line 4 in FIG. 1 merely for the sake of clarity. Obviously messages transmitted through tunnels are transmitted via the connecting line 4. The measuring transducer 13 is a comparatively simple device with low computing power and therefore is not itself capable of producing a tunnel end point. The secure switch 24 forms a substitute for production of the tunnel end point for this device and for the two further devices 12 and 14 located in the subnetwork 20. The secure switches 16 and 26 also assume a substitute function in a corresponding manner. The secure switches 16, 24 and 26 are layer 3 switches which use the IPsec protocol to produce the tunnel end points.

To distinguish the ports 18, 19, 21, 22, 23 and 27, which like conventional ports of a switch are not capable of producing a tunnel end point, the ports 17, 25 and 28 of the secure switches 16, 24 and 26 are provided with a colored marking, with a black marking in the illustrated embodiment.

As an alternative to the illustrated exemplary embodiment of the automation network 1, the switch 16 could be omitted if the operating and monitoring device 10 and the programming device 11 were themselves capable of producing a tunnel end point. In this case these devices would be directly connected to the connecting line 4 and a global tunnel would have a respective end point in the operating and monitoring device 10, in the programming device 11 and, in the same form as described above with reference to FIG. 1, in the secure switches 24 and 26. However, this variant would have the drawback that the resources for producing a tunnel end point would be required in the two devices 10 and 11, so there would be lower capacities available for their actual functions of automation engineering. The shared secret would then have to be held in all tunnel end points, i.e. in the devices 10 and 11 as well as in the secure switches 24 and 26.

By using the switch 24 in the subnetwork 20 all connections of the network subscribers, in this case the automation device 12, the measuring transducer 13 and the operating and monitoring device 14 are produced by point-to-point connections. A structure of this type is frequently called a switched network, in particular a switched Ethernet. Alongside other measures it allows the real-time conditions required in an automation environment to be met.

The programming device 11 is used in the automation network 1 as a configuration tool with which, in addition to the conventional configuring in automation networks, the project engineer, when using secure switches, additionally determines in which network the secure switches are located and which subscribers located downstream of them should be protected. These inputs are usually easy to implement for an automation engineer. For example a secure switch, in this case the secure switch 24, is placed upstream of all devices which form part of a production cell, as in the illustrated embodiment upstream of devices 12, 13 and 14. The communications partners and the addresses thereof, for example IP addresses, network connections via which these communications partners are connected to each other, automation functions and their communication with each other and the position of the secure switch in the network are determined with the configuration tool. The following parameters, by way of example, can automatically be ascertained with reference to these determinations for construction of the tunnel: addresses of the individual tunnel end points, with which other tunnel end points a specific tunnel end point has to construct tunnels, generation of the secrets and/or certificates.

It can be established via the properties of the secure switches, application profiles or the user's project-global settings which ports of switches are secure, which tunnel protocol is to be used and/or which security settings are used, for example encryption methods, integrity protection methods, authentication methods, period of validity of the keys, etc.

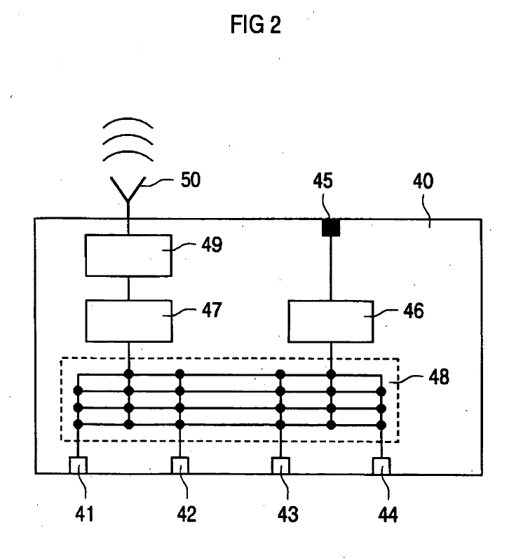

FIG. 2 shows the basic construction of a secure switch 40. T he construction of the secure switch 40 is similar to that of a conventional so -called manageable switch which can be addressed via a separate IP address or via an additional serial interface, not shown in FIG. 2 for the sake of clarity. Ports 41, 42, 43 and 44 are “normal” ports and constructed in the manner that is customary in conventional switches. Port 45 is a secure port, which is capable of producing a tunnel end point for secured transmission of data to another tunnel end point. For this purpose it is supplemented, compared with a conventional port, with what is known as a secure channel converter 46. A further secure channel converter 47 is located between a switch matrix 48 and a WLAN end point 49 which satisfies the functions of a WLAN access point and with which wireless communication can be carried out with a tunnel protocol via an antenna 50. With respect to the security functions, this port for wireless communication does not differ from the wired secure port 45, so it is sufficient to describe the functions of the secure switch 40 with reference to the secure port 45. All messages that are transmitted from the secure port 45 pass through the secure channel converter 46. An Ethernet packet is secured as required, for example converted into an IP packet and secured using the IPsec protocol. Thereafter the message is constructed like a normal packet of the tunnel protocol and can be conveyed via an IP infrastructure, which, for example, also contains routers. The security mechanisms prevent unauthorized modifications and unauthorized interception of the tunnel packet. In receive mode the packet is initially tested after receipt for the following properties by way of example:

has the maximum admissible received data rate been exceeded (DoS protection),

is the received message of the tunnel protocol type, with IPsec for example AH or ESP,

does the packet originate from an authorized sender (authentication),

is the packet unchanged (integrity) and/or

has the packet been received already (replay protection)?

If one of these tests turns out negative the packet is rejected and a logging entry is optionally made for a system analysis.

If these tests are successfully passed, the packet is forwarded to t he receiver in unpacked form, i.e. in the form originally transmitted by the subscriber. Unpacking can optionally include decryption. In the secure switch the unpacked packet can optionally be subjected in advance to further tests in the sense of conventional packet filters. As a result it is possible to produce finely graded access protection. This is based, for example, on IP addresses which in this case can be trusted as the packets have arrived via a secure tunnel. Following the tests and unpacking in the security channel converter 46 the packet is conventionally forwarded via the switch matrix 48 to one of the switch ports 41 . . . 44 and thus passed to the receiving subscriber.

Achieving the substitute function through a secure switch has for example the advantage compared with using a known VPN router that it is suitable for subsequent installation in existing flat networks, as are frequently encountered in automation engineering. A VPN router would require formation of subnetworks as well as a specific configuration on the subscribers, which want to communicate securely via the VPN tunnel, as the IP address of the VPN router as a gateway has to be registered with all communications partners, and the VPN router could only tunnel IP packets. Level 2 packets, as sometimes occur in automation engineering, would not be tunneled through the VPN router therefore and after the introduction of VPN routers into the automation network not all protocols would continue to work. By contrast, the described secure switch 40 can be integrated into an existing network virtually without reaction. It works like a conventional switch but with one or more secure port(s). For this reason it does not require any, or depending on the embodiment, requires one, IP address(es), any subnetwork formation, or reconfiguring of the end terminals involved in commuincation, and all traffic from level 2 of the 7-layer model can be tunneled.

1-7. (canceled)

8. An arrangement for securing data access of a first subscriber or a plurality of first subscribers arranged in a first sub-network of an automation network to a second subscriber or a plurality of second subscribers arranged in a second sub-network of the automation network, the arrangement comprising at least one secure-switch connected upstream of the first subscriber or the plurality of first subscribers for establishing a tunnel to the second subscriber or the plurality of second subscribers, the tunnel configured to securely transmit data via an insecure network, wherein
the secure-switch is an Ethernet switch and at least one port of the tunnel is a layer-3-port for establishing a tunnel end point in accordance with the Ipsec-protocol, and
the secure switch is configured to establish the tunnel representative for the first subscriber or the plurality of first the and to allocate the tunnel to the first subscriber or the plurality of first subscribers using a subscriber address of the first subscriber or the plurality of first subscribers.

9. The arrangement according to claim 8, further comprising a configuration tool for configuring the automation network, the configuration tool configured to generate parameter data related to the secure-switch and to automatically transmit the generated data to the secure-switch.

10. The arrangement according to claim 8, wherein the secure-switch comprises at least one port configured as a WLAN end point for establishing a tunnel end point.

11. The arrangement according to claim 8, wherein the secure-switch comprises at least one port configured to be used as a tunnel end point, the at least one point having a marker.

12. The arrangement according to claim 11, wherein the marker is switchable.

13. A secure-switch for securing data access of a first subscriber or a plurality of first subscribers arranged in a first sub-network of an automation network to a second subscriber or a plurality of second subscribers arranged in a second sub-network of the automation network, wherein
the secure switch is configured to be connected upstream of the first subscriber or the plurality of first subscribers, and
the secure switch is an Ethernet switch having at least one port embodied as a layer-3-port for establishing a tunnel end point in accordance with the IPsec protocol, the secure switch comprising a Secure Channel Converter for establishing a tunnel to the second subscriber or the plurality, of second subscribers, the tunnel configured to securely transmit data via an insecure network, wherein the Secure Channel Converter is configured to establish the tunnel representative for the first subscriber or the plurality of first subscribers and to allocate the tunnel to the first subscriber or the plurality of first subscribers using a subscriber address of the first subscriber or the plurality of first subscribers.
